(19) United States
(12) Patent Application Publication
(10) Pub. No.: US 2009/0175252 A1
(43) Pub. Date: Jul. 9, 2009

(54) SYSTEM AND METHOD FOR CONNECTING NODES TO A HETEROGENEOUS NETWORK WITHOUT USING A BRIDGE CONCEPT

(75) Inventor: Takashi Sato, Cupertino, CA (US)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: NXP B.V., Eindhoven (NL)

(21) Appl. No.: 12/296,025

(22) PCT Filed: Apr. 6, 2007
(86) PCT No.: PCT/IB2007/051244

§ 371 Date: Oct. 3, 2008

Related U.S. Application Data
(60) Provisional application No. 60/791,101, filed on Apr. 10, 2006.
(60) Provisional application No. 60/848,556, filed on Sep. 29, 2006.

(51) Int. Cl. H04W 84/02

(52) U.S. Cl. 370/338

(57) ABSTRACT

A wireless station (102) connecting nodes via a wireless network. The wireless station has a programmable physical layer (204) physically connected to communicate with at least one local node (142); and a controller (212) configured to detect at least one remote node (134) over the wireless network and enable communications between the local node and the remote node. Also there is a wireless network (105) having multiple nodes capable of wirelessly connecting the nodes to the network, having a first wireless station (102) capable of representing more than one remote node and having a programmable 1394 Standard physical layer, the first wireless station physically connected to at least one local node (142) and representing at least one remote node to the local node and a controller (212) configured to detect at least one remote node and enable communications between the local node and the remote node.

The present disclosure includes subject matter in common with, but is otherwise unrelated to, U.S. Pat. Nos. 6,445,690 and 6,445,691, both issued Sep. 3, 2002, which are hereby incorporated by reference herein. The present disclosure also includes subject matter in common with, but is otherwise unrelated to, copending U.S. patent application Ser. No. 09/709,269 filed Nov. 9, 2000, entitled “SYSTEM AND METHOD FOR CONNECTING NODES TO A NETWORK VIA NON-NETWORK COMPLIANT LINKS WITHOUT USING A BRIDGE CONCEPT”, which is hereby incorporated by reference herein.

The present invention is directed to a system and method for connecting nodes to a communications network, and more specifically, to a system and method for connecting nodes to a heterogeneous network without using a bridge concept.

It is a common practice to connect electronic devices in a network. A typical example is a network of computers in which each computer in the network is capable of communicating with the other computers in the network. Network devices usually communicate over an information bus that conforms to an established standard such as the IEEE 1394 standard. The IEEE 1394 standard is described in detail in the publication IEEE Standard 1394-1995, “IEEE Standard for a High Performance Serial Bus” dated Aug. 30, 1996, which is hereby incorporated into this document by reference for all purposes.

The IEEE 1394 standard is a particularly useful standard for high performance bus interconnection of computer peripherals and consumer electronics. It is also useful for transmission of high-speed digital video data.

However, its use has been limited to small clusters of devices mainly due to hassles of laying out long cables and/or the need for the IEEE 1394.1 bridge technology (IEEE standard 1394.1-2004) to enable a 1394-based heterogeneous network. A bridge circuit is an electronic circuit that is capable of connecting two or more electronic buses. The 1394.1 bridge technology is conventionally required to enable a heterogeneous network such as a network consisting of multiple 1394 bus clusters connected via a wireless network; however it limits the usefulness of legacy 1394 devices already on the market, which may not support the 1394.1 bridge technology.

There is a need in the art for a system and method for providing technology that will eliminate the need for the IEEE 1394.1 bridge concept, and enables legacy 1394 devices to communicate with each other as if all the devices are in a single 1394 network.

One disclosed embodiment includes, for use in a wireless network having multiple nodes, a wireless station connecting nodes via the network. The wireless station includes a programmable physical layer physically connected to communicate with at least one local node, and a controller configured to detect at least one remote node over the wireless network and enable communications between the local node and the remote node.

Another disclosed embodiment includes a wireless network having multiple nodes capable of wirelessly connecting the nodes to the network. The wireless network includes a first wireless station capable of representing more than one remote node and having a programmable 1394 Standard physical layer, the first wireless station physically connected to at least one local node and representing at least one remote node to the local node. The wireless network also includes a controller associated with the first wireless station configured to detect at least one remote node over the wireless network and enable communications between the local node and the remote node.

Another disclosed embodiment includes a method, for use in a network having multiple nodes, for connecting nodes to the network. The method includes providing a wireless station in communication with the wireless network, the wireless station physically attached to at least one local node, and detecting remote nodes over the wireless network. The method also includes representing the detected remote nodes to the at least one local node. In another embodiment, the method further includes sending an identifier associated with the local node over the wireless network.

The foregoing has outlined rather broadly the features and technical advantages of the present invention so that those skilled in the art may better understand the Detailed Description of the Invention that follows. Additional features and advantages of the invention will be described hereinafter that form the subject of the claims of the invention. Those skilled in the art should appreciate that they may readily use the conception and the specific embodiment disclosed as a basis for modifying or designing other structures for carrying out the same purposes of the present invention. Those skilled in the art should also realize that such equivalent constructions do not depart from the spirit and scope of the invention in its broadest form.

Before undertaking the Detailed Description of the Invention, it may be advantageous to set forth definitions of certain words and phrases used throughout this patent document: the terms “include” and “comprise” and derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller,” “processor,” or “apparatus” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

For a more complete understanding of the present invention, and the advantages thereof, reference is now made to the following descriptions taken in conjunction with the accompanying drawings, wherein like numbers designate like objects, and in which:

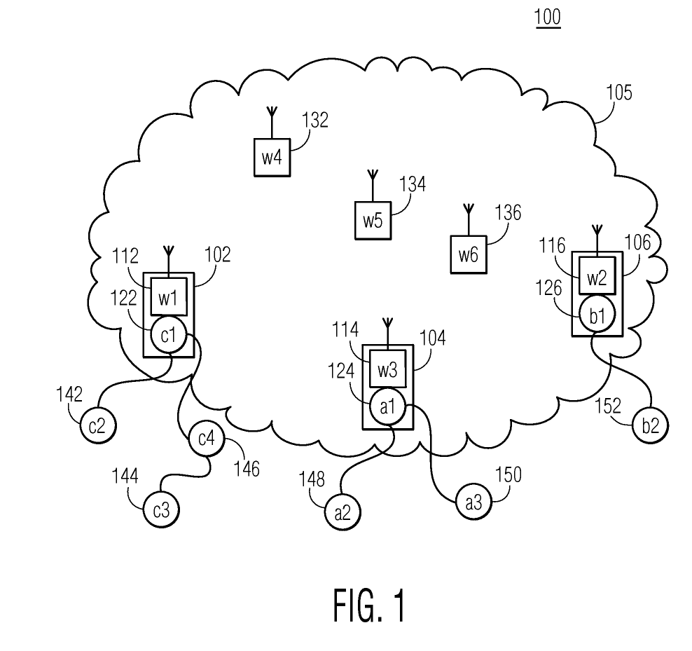

FIG. 1 illustrates a block diagram of an exemplary communications system;

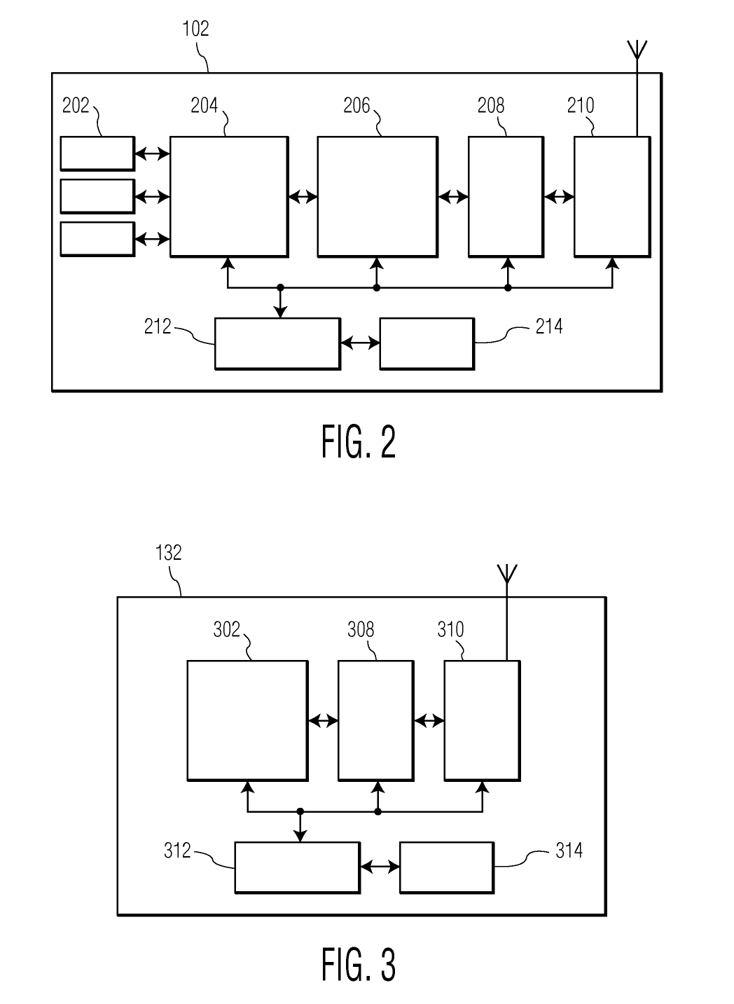

FIG. 2 illustrates a block diagram of a wireless station in accordance with an embodiment of the present disclosure;

FIG. 3 depicts a block diagram of a wireless node in accordance with a disclosed embodiment; and

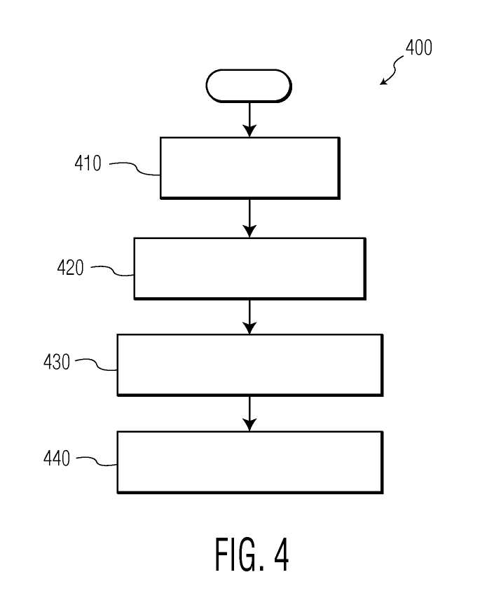

FIG. 4 is a flow diagram illustrating the operation of an advantageous embodiment of the present invention.

FIGS. 1 through 4, discussed below, and the various embodiments set forth in this patent document to describe the principles of the system and method of the present invention are by way of illustration only and should not be construed in any way to limit the scope of the invention. In the descriptions of the advantageous embodiments that follow, the present invention is integrated into, and is used in connection with, a network communications system. The present invention will be described as a system and method for connecting network nodes via non-network compliant links without using a bridge concept. It is important to realize that the method of the present invention is not limited to a network communications system. Those skilled in the art will readily understand that the principles of the present invention may also be successfully applied in any similar type of network system. In the descriptions that follow, a network communications system is employed for illustration purposes only.

The IEEE 1394.1 bridge technology is complex, and it limits the usefulness of legacy 1394 devices that are currently on the market. The IEEE 1394.1 bridge does not allow a legacy device to initiate transactions or communications across bridge(s), thus significantly limits the usefulness of legacy devices in such a network. It requires a controlling device to be bridge-aware for it to initiate transactions across bridge(s). The complexity of the 1394.1 technology and its limitations for legacy devices have been a major factor in hindering the deployment of 1394-based heterogeneous networks or wireless 1394 technologies.

FIG. 1 illustrates a block diagram of an exemplary communications system 100. Communications system 100 comprises a wireless network 105, which in turn comprises a plurality of wireless nodes w1 112, w2 116, w3 114, w4 132, w5 134, and w6 136, each shown as a square block in FIG. 1, and 1394 bus clusters, each of which is shown as a group of circles connected by curved lines representing physical, wired connections. A “node” in communications system 100 is defined to be any device that is capable of producing, processing, utilizing, or transmitting information. Each wireless node is capable of wireless communication with other wireless node. “Wireless communication” in communications system 100 is defined to be the communication of information through space (i.e., not through wires or similar conduits) by an energy propagation mode (e.g., radio frequency (RF), infrared (IR), sonic energy) that is capable of carrying the information being communicated, using any appropriate protocol, including but not limited to WiFi, BLUETOOTH, WiMax, and other known wireless protocols. The various nodes, in combination with the wireless network 105, form a heterogeneous network as communications system 100.

Each wireless node also includes, in addition to an information processing device, a transceiver (not shown) for wireless communication. Each wireless node is capable of coordinating the local flow of information between their respective information processing devices and their respective transceivers. In addition, each wireless node includes, in addition to a transceiver, a transducer (not shown) for propagating the energy of the energy propagation mode used for wireless communication.

Wireless nodes that are not a part of a wireless station, such as wireless nodes w4 132 and w6 136, can be wireless 1394 nodes. In this exemplary embodiment, wireless node w5 134 is an ordinary wireless node and not a wireless 1394 node. A wireless 1394 node is a 1394-aware wireless node that uses 1394 protocols and can communicate with other wireless 1394 nodes and 1394 nodes on any 1394 bus clusters via wireless stations. The wireless 1394 node, in this embodiment, does not contain a standard 1394 node.

FIG. 1 also includes a plurality of 1394 nodes c1 122, c2 142, c3 144, c4 146, a1 124, a2 148, a3 150, b1 126, and b2 152, each shown as a circle in FIG. 1. In this exemplary embodiment, each of the 1394 nodes that are not part of a wireless 1394 station, described below, are conventional 1394 nodes or devices as known to those of skill in the art.

1394 nodes c1 122, c2 142, c3 144, and c4 146 are connected by wire to form a conventional 1394 bus cluster. Similarly, 1394 nodes a1 124, a2 148, and a3 150 are connected by wire to form a conventional 1394 bus cluster, and 1394 nodes b1 126, and b2 152 are connected by wire to form a conventional 1394 bus cluster.

Also shown are wireless 1394 stations 102, 104, and 106, each having a respective wireless node and a 1394 node. Wireless 1394 stations 102, 104, and 106 each acts as an intelligent router between a local 1394 bus cluster and the wireless network.

1394 nodes 122, 124, and 126, as part of wireless stations 102, 104, and 106, respectively, each have a programmable 1394 Physical layer and a programmable 1394 Link layer. As described herein, using the programmable 1394 Physical layer and the programmable 1394 Link layer, the 1394 nodes 122, 124, and 126 in wireless 1394 stations 102, 104, and 106 each represent nodes on the remote 1394 bus clusters as well as the wireless 1394 nodes on the wireless network. Each wireless station therefore represents its local nodes to the other devices on the wireless network, and represents the other 1394 devices in the network to its local nodes.

In this figure, for example, 1394 node a1 126 represents, to its 1394 node cluster, 1394 nodes c2 142, c3 144, c4 146, and b2 152, as well as wireless 1394 nodes w4 132 and w6 136. 1394 node b1 126 represents, to its 1394 node cluster, 1394 nodes c2 142, c3 144, c4 146, a2 148, and a3 150, as well as wireless 1394 nodes w4 132 and w6 136. 1394 node c1 122 represents, to its 1394 node cluster, 1394 nodes a2 148, a3 150, and b2 152, as well as wireless 1394 nodes w4 132 and w6 136.

FIG. 2 illustrates a block diagram of a wireless station 102 in accordance with an embodiment of the present disclosure.

Wireless station 102 includes wireless physical layer 210 (with antenna system), which communicates with wireless medium access control (MAC) layer 208. Wireless MAC layer 208 communicates with programmable 1394 link layer 206, which in turn communicates with programmable 1394 physical layer 204. Programmable 1394 physical layer 204 communicates with at least one 1394 port 202. Wireless station controller 212 communicates with memory 214, and is connected to communicate with and control each of physical layer 210 (with antenna system), wireless MAC layer 208, programmable 1394 link layer 206, and programmable 1394 physical layer 204.

Each 1394 port 202 connects to other nodes on the local 1394 bus cluster via 1394 cables. Each 1394 node, including node c1 122 in wireless station 102, can have one to 27 ports per the IEEE 1394 standard.

In some embodiments, to be compatible with network 105, wireless station 102 to supports the common network physical layer. Wireless station 102 identifies itself to network 105 by using its medium access control identifier. Wireless physical layer 210 can be implemented in hardware in order to carry out operations in both the analog and the digital domain.

Programmable 1394 physical layer 204 can be programmed by controller 212 so that it can generate multiple SelfID packets after each bus reset and appears to other nodes on the local bus that there are multiple nodes in its place. Programmable 1394 physical layer 204, in some embodiments, generates multiple SelfID packets by incrementing the physical identification number in a first SelfID packet to create a second Self ID packet, a third SelfID packet, and so on. As will be understood by those of skill in the art, programmable 1394 physical layer 204 also makes necessary adjustments to other fields in the Self ID packets, such as port status fields. Programmable 1394 physical layer 204 can also receive packets addressed to all the Physical layer address (PhyIDs) that it represents. Other aspects of the communication between nodes and wireless stations, and other internal operations, can be accomplished, for example, using techniques as described in the patents and patent application incorporated by reference above.

The programmable 1394 link layer 206 can be programmed by controller 212 so that it can represent multiple nodes in cooperation with the programmable 1394 physical layer 204. Programmable 1394 link layer 206 can generate packets with the source address of any node that it represents, and receive packets to the destination addresses of all the nodes that it represents.

The wireless Medium Access Control (MAC) layer and the wireless Physical layer are convention wireless MAC and Physical layers, including but not limited to one of the IEEE 820.11 family technologies or an Ultra WideBand (UWB) technology. It could also be a non-wireless technology such as a power-line communication technology. Controller 212 communicates with other wireless 1394 stations and wireless 1394 nodes via the wireless network, and controls communications between its local 1394 bus cluster and the rest of the network.

Controller 212 discovers the 1394 nodes on the remote 1394 bus clusters via other wireless stations as well as wireless 1394 nodes w4 132 and w6 136 on the wireless network 105. Then, Controller 212 programs programmable 1394 physical layer 204 and programmable 1394 link layer 206 so that they represent those discovered nodes to the local 1394 bus cluster in a form of virtual nodes. Controller 212 also maintains the one-to-one relationships between the corresponding virtual and real nodes, and forwards communications back and forth between the corresponding virtual and real nodes.

A virtual node, as used herein, is a virtual entity that appears to other real nodes on the local 1394 bus cluster as if it exists on the local 1394 bus cluster although it is actually a wireless 1394 node or part of a remote 1394 bus cluster that exists in other part of the network.

In communications system 100, wireless station 102 detects wireless nodes, w2 116, w3 114, w4 132, and w6 136, and associated 1394 nodes a2 148, a3 150, and b2 152. Nodes a1 124 and b1 126, in this embodiment, as part of wireless stations, are not detected as separate nodes. An ordinary wireless node w5 134 is also ignored as it is not part of the 1394 network. The controller 212 in the wireless station 102 sends instructions to its programmable 1394 physical and link layers to create corresponding virtual nodes for each of these detected nodes. Programmable 1394 physical and link layers then present each of these virtual nodes to its connected 1394 bus cluster as physical nodes.

Note that during this detection, each of the other wireless stations will respond with a unique node ID for each 1394 node physically connected to it, in this embodiment.

Wireless station 102 receives from other wireless stations and wireless nodes all the packets that are to be delivered to nodes c2 142, c3 144, and c4 146, which are connected (directly or indirectly) to 1394 ports 202 as a 1394 bus cluster. When a device on network 105 sends request packets to nodes c2 142, c3 144, or c4 146, wireless station 102 receives those packets and forwards them to the corresponding node c2 142, c3 144, or c4 146, after replacing the source node ID in each packet with the corresponding virtual node ID. When wireless station 102 receives the response from node c2 142, c3 144, or c4 146, it generates the response packet to the requester, with its source ID in the packet replaced with the corresponding unique node ID.

From the point of view of the local 1394 bus cluster, wireless station 102 behaves as if there were five nodes in its place (i.e., node a2 148, node a3 150, node b2 152, node w4 132, and node w6 136). Legacy devices on the local 1394 cluster can communicate with any one of node a2 148, a3 150, b2 152, w4 132, or w6 136 via a wireless link. In this manner, the system and techniques disclosed herein enable 1394 devices to be connected to a network without using a bridge concept.

The wireless 1394 station mimics behavior of standard 1394 nodes on the local 1394 bus cluster because local 1394 nodes can only understand the standard 1394 protocol. On the other hand, on the wireless network side, other protocols can be used or defined for communications among wireless 1394 stations and wireless 1394 nodes.

If the sum of the number of local nodes and the number of the remote nodes to be represented by virtual nodes exceeds 63, the controller can limit the number of the virtual nodes so that the total number of the local and virtual nodes does not exceeds 63, and can notify the user by a means of sound, light, text, and/or voice message that there are too many nodes in the network.

If there is a bus reset at the local 1394 bus cluster, controller 212 checks if a new device has been added, a device has been removed, or there is no change to the members of the local nodes. If there is any change, controller 212 informs other wireless 1394 stations and wireless 1394 nodes. Upon reception of such information, each wireless 1394 station updates its virtual node information and generates a local bus reset, while wireless 1394 nodes update their list of SelfID packets. Each wireless station stores the virtual node information and SelfID packets in memory 314.

If a new wireless 1394 node is detected or one is removed, controller 212 updates its virtual node information and generates a bus reset. However, to cope with relatively unreliable nature of the wireless network, controller 212 can check the removal of a wireless 1394 node more than once over a time span of a few second to confirm the removal. This is to minimize unnecessary bus resets and improve the stability of the network.

FIG. 3 depicts a block diagram of a wireless 1394 node in accordance with a disclosed embodiment, such as wireless 1394 node w4 142. Wireless 1394 node w4 142 includes wireless physical layer 310 (with antenna system), which communicates with wireless medium access control (MAC) layer 308. Wireless MAC layer 308 communicates with 1394 application 302. Wireless 1394 node controller 312 communicates with memory 314, and is connected to communicate with and control each of wireless physical layer 310, wireless medium access control (MAC) layer 308, and 1394 application 302.

Wireless 1394 node w4 142 does not contain a conventional 1394 node. Wireless 1394 node w4 142 is a wireless node compliant to the wireless network, but it also understands 1394 protocols and implements registers (virtual or real) according to the IEEE 1394 standard.

Wireless 1394 node w4 142 may contain an application block as 1394 application 302. For example, it can be a source or a sink for an audio or a video stream. 1394 application 302 can also be a remote controller. In that case, 1394 application 302 can include user interface devices (e.g., input keys and a display). In some embodiments, some or all of the 1394 application programming resides in the memory 314 of the wireless 1394 node 132.

Wireless 1394 node 132 communicates with other wireless 1394 nodes and 1394 nodes on 1394 bus clusters via wireless 1394 stations by exchanging 1394 packets encapsulated in radio packets, using conventional communication techniques. In some embodiments, the wireless 1394 station maintains a table that tells which virtual node ID corresponds to the remote unique node ID and a table that tells which remote unique node ID corresponds to the MAC ID on the wireless network.

The embodiments and techniques disclosed herein can be implemented in IEEE 1394 based home networks. The embodiments and techniques disclosed herein enable multiple 1394 clusters to communicate with each other, for example, via a wireless network, making full use of the legacy 1394 devices on the market.

FIG. 4 is a flow diagram illustrating the operation of an advantageous embodiment of the present invention in an exemplary network communications system. The first step comprises providing a wireless station in communication with a wireless network and physically connected to communicate with at least one local 1394 node (step 410).

The next step comprises detecting at least one remote 1394 node over the wireless network (step 420). The 1394 node can be a wireless 1394 node or a 1394 node connected to another wireless station.

The next step comprises representing the detected remote nodes to the each of the local nodes on the local 1394 bus cluster (step 430).

The final step comprises routing communications between the remote node(s) and the local 1394 node(s) over the wireless network (step 440).

Although FIG. 4 illustrates one example of a method 400 in accordance with disclosed embodiments, various changes may be made to FIG. 4. For example, one, some, or all of the steps may occur as many times as needed. Also, while shown as a sequence of steps, various steps in FIG. 4 could occur in parallel or in a different order. As a particular example, some steps shown in FIG. 4 could be performed in parallel.

Those skilled in the art will recognize that, for simplicity and clarity, the full structure and operation of all systems and elements suitable for use with the present disclosure is not being depicted or described herein. Instead, only so much of the systems and elements as is unique to the present disclosure or necessary for an understanding of the present disclosure is depicted and described. The remainder of the construction and operation of the systems and elements illustrated and described herein may conform to any of the various current implementations and practices known in the art.

It is important to note that while the present invention has been described in the context of a fully functional system, those skilled in the art will appreciate that at least portions of the mechanism of the present invention are capable of being distributed in the form of a instructions contained within a machine usable medium in any of a variety of forms, and that the present invention applies equally regardless of the particular type of instruction used to actually carry out the distribution. Examples of machine usable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present invention has been described in detail, those skilled in the art will understand that various changes, substitutions, variations, and improvements of the invention disclosed herein may be made without departing from the spirit and scope of the invention in its broadest form.

1. A wireless station for use in a wireless network having multiple nodes connecting said nodes via said network comprising:
a programmable physical layer physically connected to communicate with at least one local node; and
a controller configured to detect at least one remote node over the wireless network and enable communications between the local node and the remote node.

2. The wireless station of claim 1, wherein the programmable physical layer is a programmable 1394 Standard physical layer.

3. The wireless station of claim 1, wherein the wireless network is physically connected to communicate with a plurality of local nodes comprising a 1394 Standard bus cluster.

4. The wireless station of claim 1, wherein the controller maintains a table that identifies at least one virtual node ID and a corresponding at least one remote unique node ID.

5. The wireless station of claim 1, wherein the wireless station represents the at least one remote node to the at least one local node.

6. The wireless station of claim 1, further comprising a programmable link layer in communication with the programmable physical layer.

7. The wireless station of claim 1, wherein the controller maintains a table that identifies at least one remote unique node identifier and a corresponding at least one medium access control identifier on the wireless network.

8. A wireless network having multiple nodes capable of wirelessly connecting the nodes to said network comprising:
a first wireless station capable of representing more than one remote node and having a programmable 1394 Standard physical layer, the first wireless station physically connected to at least one local node and representing at least one remote node to the local node; and
a controller associated with the first wireless station configured to detect at least one remote node over the wireless network and enable communications between the local node and the remote node.

9. The wireless network of claim 8, wherein the wireless network is physically connected to communicate with a plurality of local nodes comprising a 1394 Standard bus cluster.

10. The wireless network of claim 8, wherein the controller maintains a table that identifies at least one virtual node ID and a corresponding at least one remote unique node ID.

11. The wireless network of claim 8, wherein the wireless station represents the at least one local node to other wireless stations over the wireless network.

12. The wireless network of claim 8, further comprising a programmable 1394 Standard link layer in communication with the programmable 1394 Standard physical layer.

13. The wireless network of claim 8, wherein the controller maintains a table that identifies at least one remote unique node identifier and a corresponding at least one medium access control identifier on the wireless network.

14. The wireless network of claim 8, further comprising a second wireless node, the second wireless node comprising a controller, a memory, and a 1394 Standard application.

15. The wireless network of claim 8, wherein each wireless station represents at least one 1394 Standard node to the at least one local node.

16. The wireless network of claim 8, wherein the first wireless station represents the local node to other devices on the wireless network.

17. The wireless network of claim 8, wherein the wireless station represents the at least one local node at least one wireless 1394 node over the wireless network.

18. The wireless network of claim 8, wherein the first wireless station is capable of broadcasting a self identification packet to the at least one local node for each remote node that the first wireless station represents.

19. The wireless network of claim 8, wherein the network includes a plurality of wireless stations, each wireless station associated with at least one local node, and a plurality of wireless nodes, each wireless node associated with a 1394 Standard application.

20. A method for connecting nodes in a network comprising the steps of:
providing a wireless station in communication with the wireless network, the wireless station physically attached to at least one local node;
detecting remote nodes over the wireless network; and
representing the detected remote nodes to the at least one local node.
